(19) United States
(12) Patent Application Publication
(10) Pub. No.: US 2024/0105392 A1
(43) Pub. Date: Mar. 28, 2024

(54) An Improved Tantalum Electrode and Related Methods

(71) Applicant: BIOTRONIK SE & Co. KG, Berlin (DE)

(72) Inventors: Bernd PRETZLAFF, Mildstedt (DE); Janosch LICHTENBERGER, Bremen (DE); Salah HABOUTI, Husum (DE)

(73) Assignee: BIOTRONIK SE & Co. KG, Berlin (DE)

(21) Appl. No.: 18/261,877

(22) PCT Filed: Feb. 11, 2022
(86) PCT No.: PCT/EP2022/053316

§ 371 Date: Jul. 18, 2023

(30) Foreign Application Priority Data
Feb. 19, 2021 (EP) 21158020.4

(51) Int. Cl. H01G 9/00; C25D 11/02; C25D 11/26; H01G 9/052

(52) U.S. Cl. CPC H01G 9/0029; C25D 11/022; C25D 11/26; H01G 9/0032; H01G 9/052; H01G 2009/05

(57) ABSTRACT

The invention relates to a method for manufacturing a structured cathode of an electrolytic capacitor, comprising the following steps: a) filling an electrically conductive coating composition into a micro extruder; b) moving the micro extruder with a computer-assisted electric movement system relatively to a cathode current collector to be coated, wherein the movement system allows a relative movement between the micro extruder and the cathode current collector with at least three degrees of freedom; c) applying the coating composition in a desired thickness and in a desired pattern onto the cathode current collector without contacting the cathode current collector with the micro extruder.

### CROSS-REFERENCE TO RELATED APPLICATIONS

This application is the United States National Phase under 35 U.S.C. § 371 of PCT International Patent Application No. PCT/EP2022/053316, filed on Feb. 11, 2022, which claims the benefit of European Patent Application No. 21158020.4, filed on Feb. 19, 2021, the disclosures of which are hereby incorporated by reference herein in their entireties.

### TECHNICAL FIELD

The present invention relates to a method for manufacturing a structured cathode of an electrolytic capacitor according to the preamble of claim 1, to a novel use of a micro extruder according to the preamble of claim 4, to an arrangement for forming an oxide layer on a tantalum electrode according to the preamble of claim 7, to a method for marking a tantalum electrode according to the preamble of claim 9, and to a novel tantalum electrode according to the preamble of claim 12.

### BACKGROUND

In electrolytic capacitors, e.g., in tantalum or niobium electrolytic capacitors, the cathodic potential lies on an electrically conductive housing, the inner surface of the housing is coated with an electrically conductive material acting as a cathode, typically comprising carbon. Numerous processes for coating surfaces are known from prior art. U.S. Publication No. 2006/0198082 A1, for example, describes a sputter process for coating surfaces. The disadvantage here is that the surfaces must be masked in order to obtain a structured coating of the surface. In addition, a sputtering process is generally not effective in terms of material usage because a lot of material is distributed unused in the recipient. This is a major disadvantage, especially in case of valuable coating materials. Also, many materials cannot be sputtered at all or only poorly; compounds or mixed materials with exact stoichiometric ratios require expensive targets.

U.S. Publication No. 2006/0154416 A1 describes a pad printing process for coating surfaces. The pad printing process is based on the transfer of a coating liquid or coating ink from a sponge wetted with it to a surface to be coated. In order for the coating liquid or coating ink to be transferred completely from the sponge to the surface to be coated, the physical properties—in particular the viscosity, surface tension, temperature—of the coating liquid or coating ink must match those of the sponge and the surface exactly. The layer thickness produced also depends on these parameters. Under certain circumstances, no ideal set of process parameters is possible that meets all the requirements of the layer. In particular, requirements for the layer thickness are difficult to implement, since multiple printing of the layer often does not result in satisfactory surface coatings due to the changing printing surface. Furthermore, the process temperature during coating is limited by the thermal load capacity of the sponge. If a solvent is to be evaporated quickly, there is a risk of bubble formation under the sponge and contamination of the sponge. A further disadvantage is that housing parts with bottom, radii and side walls are difficult to print homogeneously.

U.S. Pat. No. 7,687,102 B2 describes a piezoelectric spraying process to apply carbon coatings on cathode current collectors. Piezoelectric systems are limited to certain coating liquids or coating inks; liquids with high viscosity or coating pastes are difficult or impossible to process.

The low viscosities required for the piezoelectric process cause the sprayed or metered webs to diverge; precise coating geometries can only be produced with very thin coatings. For thicker coatings, the surface geometry to be produced must then be run over several times. If a geometrically precise coating is to be applied, the piezoelectric spray head must not be far away from the coating surface. At high coating temperatures, however, the head then tends to overheat.

Furthermore, tantalum electrodes are typically provided with an oxide layer (so-called forming) in a forming bath with a stainless steel electrode. Tests have shown that components from the stainless steel electrode are transferred to the forming bath. There is a risk that the components dissolved from the stainless steel, such as nickel, will be deposited in the oxide layer to be formed on the tantalum electrode and thus lead to an increased residual current in a capacitor in which such a tantalum electrode is installed. This must be avoided.

A relatively obvious solution would be to use tantalum as the material for the electrode in the forming bath. Although tantalum is much more expensive than stainless steel, it has the advantage that no foreign material can be released. Experiments have now shown that oxide layers form on the tantalum connected as cathode during the forming process, which act as an insulator and thus impair the forming process. These oxide layers are easily recognized by discoloration. In principle, it would be possible to remove oxide layers on tantalum by vacuum glowing. However, this would require a considerable amount of time and expense.

The identification and traceability of individual components of a capacitor is an important requirement of quality assurance. In tantalum electrolytic capacitors, the tantalum anode is one of the most important components that decisively determines the quality. It is therefore desirable to make the tantalum anode identifiable and traceable through the manufacturing process. In this way, relevant process and quality data can be directly assigned to each individual tantalum anode via identification and traceability.

To make components identifiable and traceable, they are usually labeled, ideally with a machine-readable code. Due to the sensitivity of tantalum to impurities as well as the feared structural damage to the tantalum electrode and the associated increased leakage currents (DCL), labeling of tantalum anodes seemed impossible until now.

The present disclosure is directed toward overcoming one or more of the above-mentioned problems, though not necessarily limited to embodiments that do.

### SUMMARY

It is an object of the present invention to overcome the prior art shortcomings and to provide easier methods for making or marking a tantalum electrode, as well as connected arrangements and resulting products.

In an aspect, at least this object is achieved by a method for manufacturing a structured cathode of an electrolytic capacitor having the features of claim 1. This method comprises the steps explained in the following.

First, an electrically conductive coating composition is filled into a micro extruder. The term “micro extruder” relates to an extrusion device that is able to extrude a product, wherein the extruded product occupies a surface of less than 1 mm².

Afterwards, the micro extruder is relatively moved to a cathode current collector to be coated. This movement is achieved with a computer-assisted electric movement system. The movement system allows a relative movement between the micro extruder and the cathode current collector in at least three degrees of freedom. Thus, virtually any position between the micro extruder and the cathode current collector to be coated can be adopted so as to enable an application of the coating composition onto the cathode current collector in any desired position.

During the relative movement between the micro extruder and the current cathode current collector or after such movement in a still position, the coating composition is applied in a desired thickness and in a desired pattern onto the cathode current collector. In this context, the cathode current collector is not contacted by the micro extruder. Rather, there remains a gap between an extruding tip of the micro extruder and the cathode current collector. This avoids undesired damages of the current collector and an undesired heating-up of the micro extruder in case that the cathode current collector is heated to an elevated temperature.

In contrast to prior art solutions, the micro extruder is a micro-dosing system that enables application of coating liquids, coating inks and coating pastes onto the surface of the tantalum substrate to be coated. By adjusting the viscosity and the solvent of the coating composition as well as by adjusting the coating temperature, ideal process parameters can be predetermined that allow an application of the coating in a thickness that is ideally adjusted to the concrete coating requirements.

In contrast to prior art techniques such as sputtering, pad printing, and piezoelectric spraying of coating compositions, the micro extruder can also apply coating liquids, coating inks and coating pastes of relatively high viscosity, e.g., in the range of 0.1 to 10⁵ mPa*s. This enables also a precise application of coatings having a relatively high coating thickness, e.g., in the range of 0.1 to 500 μm.

Due to the use of the computer-assisted electric movement system, very precise surface geometries of the coating can be applied to the cathode current collector.

Since there is no direct contact between the micro extruder and the cathode current collector to be coated, the coating can also be performed at high surface temperatures of the cathode current collector. This enlarges the group of coating compositions that can be applied by the presently claimed method. Appropriate coating temperatures lie in a temperature range of from 25° C. to 300° C., in particular of from 50° C. to 250° C., in particular of from 75° C. to 200° C., in particular of from 100° C. to 175° C., in particular of from 120° C. to 150° C.

In an embodiment, the micro extruder comprises a cannula through which the coating composition is applied onto the cathode current collector to be coated. This cannula can have a particularly high length 5 mm to 50 mm so that a distance between the cathode current collector to be coated and micro extruder can be increased. In doing so, an overheating of the micro extruder and other components of the dosage system can be efficiently prevented.

In an embodiment, the movement system allows a relative translational movement of the micro extruder along three axes of a Cartesian coordinate system. Each of these three axes represents 1 degree of freedom.

In an embodiment, the movement system allows a relative translational movement of the micro extruder along three axes of a Cartesian coordinate system as well as an additional rotational tilting of the micro extruder around a tilting axis. By such an additional tilting, a fourth degree of freedom of the relative movement between the micro extruder and the cathode current collector to be coated is made available. This facilitates coating of complex surface geometries of the cathode current collector and thus enables the manufacturing of complex coating geometries.

In an embodiment, the tilting axis extends along one of the three axes of the Cartesian coordinate system.

In an embodiment, the cathode current collector is placed on a heating plate during applying the coating. Such a heating plate particularly facilitates an application of the coating at the desired coating temperature. Appropriate coating temperatures are indicated above.

By working at an elevated coating temperature, a solvent being present in the coating composition can be evaporated very quickly. This results in finely structured coating geometries that are true to size. This is of particular advantage in case of housings having a stepped electrode, such as a stepped cathode.

In an embodiment, the cathode current collector is formed at least in parts by an electrically conductive housing, particularly the inner surface of the housing. Preferably, the housing, and thus the cathode current collector is made of titanium or a titanium alloy.

In an embodiment, the electrically conductive coating composition comprises electrically conductive carbon, particularly in form of graphite, graphene, activated carbon, charcoal, carbon black, a carbon nanotube or a fullerene, or a conductive polymer. In one embodiment, the electrically conductive coating comprises a binder. In one embodiment, the binder is selected from polyvinylidene fluoride (PVDF) polytetrafluoroethylene (PTFE), carbomethyl cellulose (CMC) or a rubber, particularly acryl rubber, nitrile butadiene rubber (NBR), styrene butadiene rubber (SBR) or butyl rubber. In a preferred embodiment, the electrically conductive coating composition comprises or essentially consists of activated carbon and PVDF as binder, which are preferably solved in N-methyl pyrrolidone, which is preferably applied at about 180° C. to the cathode current collector.

In an aspect, the present invention relates to the use of a micro extruder for manufacturing a structure cathode of electrolytic capacitor. For this novel use of a micro extruder, the coating composition is applied in a desired thickness and in a desired pattern onto a cathode current collector without contacting the cathode current collector with the micro extruder.

In an aspect, the present invention relates to a method for generating a tantalum oxide layer on a tantalum electrode for a tantalum electrolytic capacitor. Such generating of a tantalum oxide layer on a tantalum electrode can also be denoted as forming. The method comprises the steps explained in the following.

First, a forming bath comprising a forming solution and a first tantalum electrode within the forming solution is provided. The forming solution may comprise, for example, ethylene glycol, polyethylene glycole 10%-90% vol/vol, water 10% to 90% and phosphoric acid, mono or poly carboxylic acids (e.g., acetic acid, oxalic acid, citric acid) 0.01 to 10%.

This first tantalum electrode is connected to a power supply. In this context, a resistor is arranged between the first tantalum electrode and the power supply.

Furthermore, a second tantalum electrode on which a tantalum oxide layer is to be formed is placed into the forming bath. This second tantalum electrode is also electrically connected with the power supply.

Afterwards, a voltage is applied by the power supply between the first tantalum electrode and the second tantalum electrode. This results in forming an oxide layer on the second tantalum electrode.

While such forming is generally known, the prior art methods resulted also in formation of tantalum oxide layers on the first tantalum electrode. These oxide layers formed on the first tantalum electrode act as insulator and impart the forming process. According to prior art techniques, it is necessary to remove such tantalum oxide layers from the first electrode by vacuum glowing the tantalum electrode. This requires additional time and effort.

By placing a resistor between the first tantalum electrode and the power supply, a current (also denoted as discharge current) circulating through the first tantalum electrode is significantly decreased. This also decreases a positive voltage being present at the first tantalum electrode. As a result, the formation of the tantalum oxide layer on the first tantalum electrode is significantly reduced so that the forming process can be accomplished with a much higher efficiency and without the need of vacuum glowing the first tantalum electrode to remove an undesired tantalum oxide layer on this first tantalum electrode. Consequently, the formation of the tantalum oxide layer on the second tantalum electrode can be achieved in a much higher efficiency.

Since not only the tantalum electrode to be coated with the tantalum oxide layer, but also the counter electrode is made from tantalum, a contamination of the oxide layer to be applied to the second tantalum electrode with foreign substances is fully avoided. In addition, placing a resistor between the second tantalum electrode and the power supply makes a regeneration of the first tantalum electrode (also denoted as forming bath electrode) superfluous.

In an embodiment, the resistor has an impedance lying in a range of from 100 kΩ (Ohm) to 20 MΩ (Ohm), in particular 2 MΩ (Ohm).

In an embodiment, the first tantalum electrode is used as cathode, and the second tantalum electrode is used as an anode during the forming process.

In an aspect, the present invention relates to an arrangement for forming an oxide layer on a tantalum electrode for a tantalum electrolytic capacitor. This arrangement comprises a container filled with a forming bath comprising a forming solution, a first tantalum electrode placed in the forming bath, a second tantalum electrode placed also the forming bath, and a power supply. The power supply is electrically connected to the first tantalum electrode and the second tantalum electrode. The first tantalum electrode serves as forming bath electrode. The second tantalum electrode is an electrode onto which a tantalum oxide layer is to be applied in the forming process.

According to this aspect of the present invention, a resistor is electrically connected between the first electrode and the power supply.

As already explained above, this resistor between the first tantalum electrode and the power supply efficiently prevents a formation of a tantalum oxide layer on the first tantalum electrode. Therefore, no costly and laborious regeneration of the first tantalum electrode is necessary. As a result, the arrangement serves for a faster and less expensive forming of the second tantalum electrode.

In an embodiment, at least a container surface facing the forming bath is made from tantalum. This additionally reduces the risk that foreign compounds are incorporated into the tantalum oxide layer to be formed on the second tantalum electrode. In an embodiment, the whole container is made from tantalum.

In an aspect, the present invention relates to a method for marking a tantalum electrode. This method comprises the steps explained in the following.

In one step, a portion of the surface of the tantalum electrode is ablated with an ultrashort pulse laser in a patterned manner, particularly with a material ablation in the range of 20 nm to 10 μm. This results in generating an identifier on the tantalum electrode.

In another method step, a tantalum oxide layer is generated on the surface of the tantalum electrode.

While prior art teaches that tantalum cannot be directly marked due to a significant risk of damaging the tantalum electrode and introducing impurities into the surface of tantalum, the inventors of the present invention surprisingly found that an ultrashort pulse laser is an efficient tool to mark a tantalum electrode without damaging it and without introducing impurities into the surface of the tantalum electrode. No increase of a leakage current could be observed after having marked a tantalum electrode with an ultrashort pulse laser.

In an embodiment, the ultrashort pulse laser emits laser pulses having a pulse duration in the order of 10⁻¹¹ seconds or less, in particular a pulse duration of 1×10⁻¹² seconds to 1×10⁻¹⁴ seconds, in particular of 0.5×10⁻¹² seconds to 1×10⁻¹³ seconds.

While it is generally possible to introduce the identifier into an already oxidized tantalum electrode surface (i.e., to perform the step of ablating a portion of the surface of the tantalum electrode after having generated the tantalum oxide layer on the surface of the tantalum electrode), the method steps are performed in an opposite sequence in an embodiment. Thus, in this embodiment, the tantalum oxide layer is formed on the surface of the tantalum electrode after having introduced the identifier into the surface of the tantalum electrode with an ultrashort pulse laser. Surprisingly, forming a tantalum oxide layer on the already marked surface will not totally cover the marking or identifier. Rather, the marking this still visible through the tantalum oxide layer so that it can be read out, e.g., by an optical measurement.

In an embodiment, an additional step of sintering the tantalum electrode is carried out after having ablated a portion of the surface of the tantalum electrode with an ultrashort put laser to introduce an identifier in the surface of the tantalum electrode and prior to generating a tantalum oxide layer on the surface of the tantalum electrode. By such a sintering process, the surface of the tantalum electrode is cleaned from undesired oxides and other impurities. Furthermore, the areas structured with the ultrashort pulse laser are recrystallized by the sintering process so that a smooth surface is obtained, even though the identifier is still present in the surface of the tantalum electrode.

In an embodiment, the identifier is a unique identifier of the tantalum electrode to allow a unique tracing of the origin of the tantalum electrode.

A particularly appropriate unique identifier is a barcode, particularly a two-dimensional barcode or data matrix code, also known as QR code. Such a unique identifier makes it possible to track the origin of the electrode and to identify any irregularities in the manufacturing process if a capacitor in which the electrode is installed does not fulfil the specifications or otherwise fails in its proper function. Consequently, the whole manufacturing process is made much more reliable and allows a high manufacturing quality and a very fast and precise identification of irregularities in the manufacturing process.

In an aspect, the present invention relates to a tantalum electrode that is obtainable with a method according to the preceding explanations. Such tantalum electrode comprises an identifier in the form of patterned surface structuring that has been introduced into the surface of the tantalum electrode with an ultrashort pulse laser. By such an identifier, the traceability of the tantalum electrode is given. Thus, the origin and any performed treatments of the tantalum electrode can be easily assigned to the specific tantalum electrode and can be retrieved by reading out the identifier of the tantalum electrode. This significantly enhances the reliability and overall quality of the manufacturing process of the tantalum electrode and thus of the resulting electrode itself.

All embodiments of the described methods can be combined in any desired way and can be transferred either individually on any arbitrary combination to any of the respective other methods, to the described use, to the described arrangement and/or to the described tantalum electrode. Furthermore, all embodiments of the described use can be combined in any desired way and can be transferred either individually or in any arbitrary combination to any of the described methods, to the described arrangement and/or to the described tantalum electrode. Furthermore, all embodiments of the described arrangement can be combined in any desired way and can be transferred either individually or in any arbitrary combination to any of the described methods, to the described use and/or to the described tantalum electrode. Finally, all embodiments of the described tantalum electrode can be combined in any desired way and can be transferred either individually or in any arbitrary combination to any of the described methods, to the described use and/or to the described arrangement.

Additional features, aspects, objects, advantages, and possible applications of the present disclosure will become apparent from a study of the exemplary embodiments and examples described below, in combination with the Figures and the appended claims.

### BRIEF DESCRIPTION OF THE DRAWINGS

Further details of aspects of the present invention will be explained in the following with respect to exemplary embodiments and accompanying Figures. In the Figures:

FIG. 1 is a schematic depiction of a micro-dosing system comprising a micro extruder;

FIG. 2 shows a variant of a micro extruder;

FIG. 3 shows a first application embodiment of the micro extruder of FIG. 2;

FIG. 4 shows a second application embodiment of the micro extruder of FIG. 2;

FIG. 5 shows a current-voltage diagram of a discharge process of a prior art forming process of a tantalum electrode;

FIG. 6 shows a current-voltage diagram of a discharge process of a forming process of a tantalum electrode according to an embodiment of the present invention;

FIG. 7A shows an embodiment of an identifier on the surface of the tantalum electrode; and

FIG. 7B shows the identifier of FIG. 7A after having subjected the tantalum electrode to a forming process.

### DETAILED DESCRIPTION

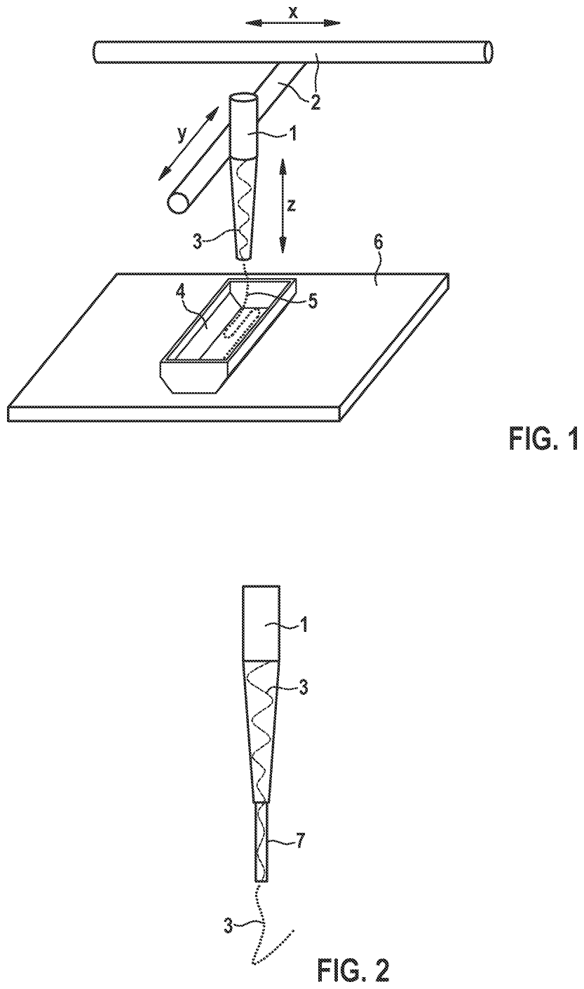

FIG. 1 shows a micro extruder 1 being mounted to an axial moving system 2, allowing a movement of the micro extruder 1 along a first axis x, a second axis y, and a third axis z. The second axis y is orthogonally arranged with respect to the first axis x. The third axis z is orthogonally arranged with respect to the first axis x and the second axis y. Thus, the three axes x, y, z make up a Cartesian coordinate system.

The micro extruder 1 is filled with a coating composition 3. This coating composition 3 is extruded onto an electrically conductive titanium housing 4 of an electrolytic capacitor, preferably of an tantalum or niobium electrolytic capacitor. In doing so, a patterned coating 5 is applied onto the housing 4, wherein the titanium housing act as a cathode current collector of the electrolytic capacitor.

The housing 4 is placed on a heating plate 6 that allows to bring the housing 4 to a desired temperature. This enables a quick evaporation of the solvent so that the patterned coating 5 will be safely kept in place on the housing 4 without drifting away.

FIG. 2 shows another embodiment of a micro extruder 1. In this and in all following Figures, similar elements will be marked with the same numeral reference.

The micro extruder 1 of FIG. 2 comprises a cannula 7, through which the coating composition 3 is extruded. This cannula 7 serves for a bigger distance between the micro extruder 1 and a housing or cathode current collector onto which the coating composition 3 is to be applied. Such a cannula 7 efficiently reduces the risk of an overheating of the micro extruder 1 if the coating composition 3 is applied to the housing or cathode current collector at an elevated temperature.

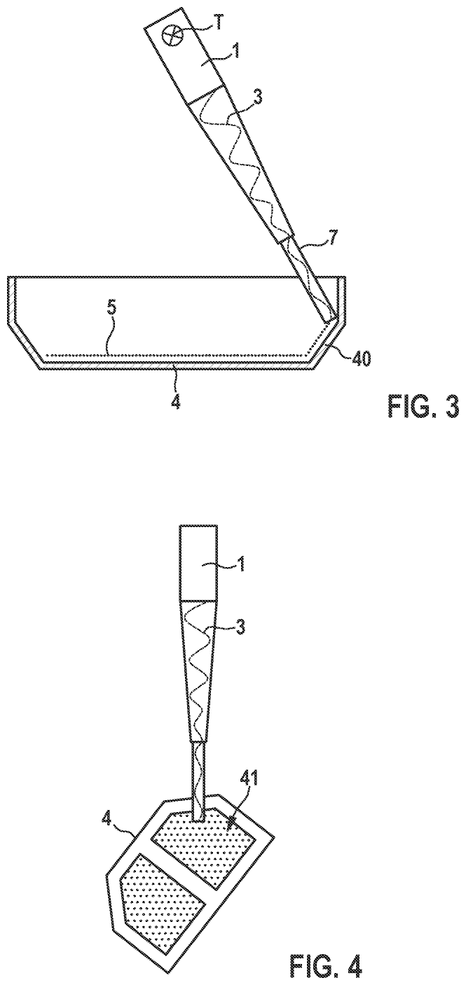

FIG. 3 shows an application mode of the micro extruder 1 of FIG. 2. In this embodiment, the micro extruder 1 cannot only be moved in a translational manner along the first axis x, the second axis y and the third axis z (cf. FIG. 1), but it can also be tilted around a tilting axis T. This tilting axis T runs along the second axis y and makes it particularly easy to coat a side wall of a titanium housing 4 acting as cathode current collector.

FIG. 4 shows a second application mode of the micro extruder 1 of FIG. 2. Here, stepped areas 41 of the housing 4 are filled with the coating substance 3. These stepped areas 41 can be easily approached by the micro extruder 1 grace to the axial movement system 2 (cf. FIG. 1).

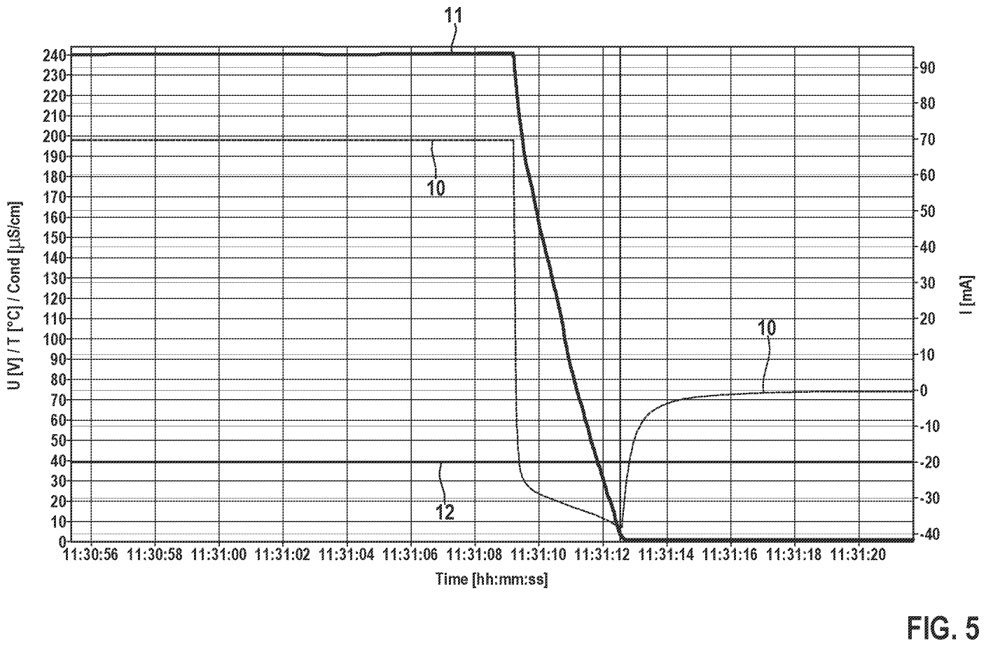

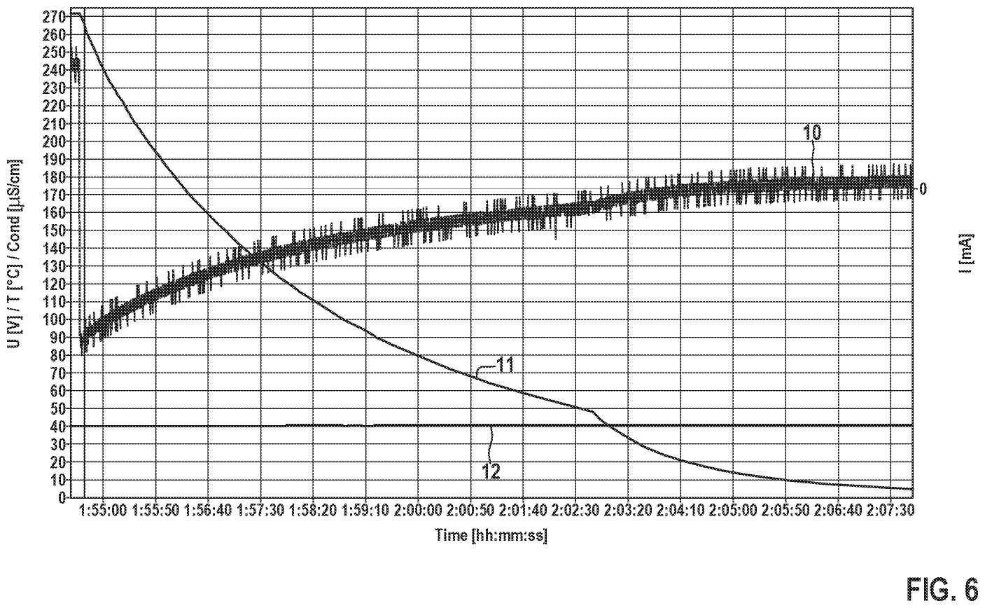

FIG. 5 shows a current-voltage diagram of a discharge process during a forming procedure of a tantalum forming electrode (cathode) according to a prior art technique. Here, a current 10 achieves a value of as much as −38 mA during the procedure. Due to this high negative current, a tantalum oxide layer is formed on the tantalum forming electrode. As a result, a voltage 11 drops and the efficiency of the forming process is also significantly reduced. Consequently, no efficient forming of a tantalum oxide layer on the electrode (anode) to be coated with an oxide layer is any longer possible. The forming process referred to in FIG. 5 is done at a constant temperature 12 of about 40° C.

The situation totally changes if a resistor is arranged between the tantalum forming electrode (cathode) and the power supply providing the necessary voltage to the tantalum forming electrode. Due to the resistor, the current 10 flowing through the forming electrode is limited to a maximum absolute value of −0.125 mA. As a result, also the positive voltage 11 on the forming electrode is reduced. Consequently, no tantalum oxide is formed on the forming electrode so that the forming electrode can be longer used for the forming process without regeneration. Consequently, the forming process of the electrode (anode) to be coated with an oxide layer was much more efficient. This experiment was also performed at a constant temperature 12 of about 40° C.

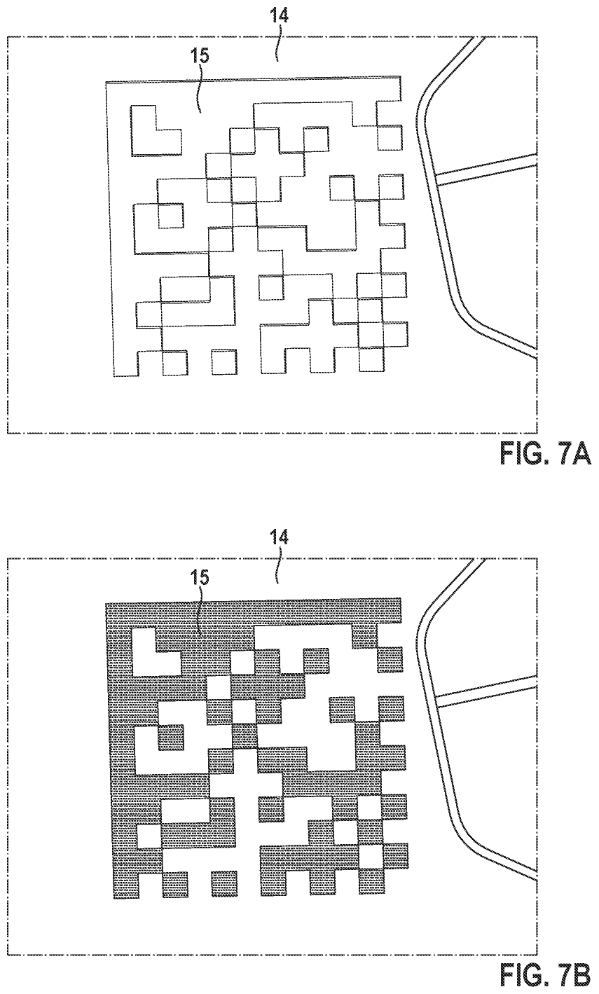

FIG. 7A shows a surface of a tantalum electrode 14 provided with a label 15 in the form of a two-dimensional data matrix. This label 15 was introduced into the surface of the tantalum electrode 14 by ablating a small portion of the surface of the tantalum electrode 14 with an ultrashort pulse laser. The labeling was done in a protective chamber with a laser window. It was worked under inert conditions with argon as protective gas. Labeling took place after pressing tantalum pallets to be used for manufacturing tantalum electrodes and prior to sintering and forming these pellets to give the final electrodes.

This ablation was done in a patterned manner so that the label 15 resulted which is made up of ablated portions and non-ablated portions of the surface of the tantalum electrode 14.

FIG. 7B shows the surface of the tantalum electrode 14 after having been subjected to a forming process, i.e., after having formed a tantalum oxide layer on the surface of the tantalum electrode 14. The label 15 is still visible and can be read out by an optical measurement.

It was completely surprising that the label 15 did not result in an increase of a leakage current of the tantalum electrode 14. For testing the leakage current, labelled tantalum anodes were compared with non-labelled tantalum anodes. The resulting leakage currents were normalized to the capacity of the underlying capacitors and the applied measuring voltage. In case of the labelled anodes, an average leakage current of 0.68 nA/μFV was determined. The average leakage current of non-labelled anodes was calculated to be 0.80 nA/μFV.

By labeling the tantalum anodes, an identification and traceability of individual electrodes is made possible. As a result, process and quality data can be uniquely assigned to individual electrodes manufactured with such a label.

It will be apparent to those skilled in the art that numerous modifications and variations of the described examples and embodiments are possible in light of the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof. Additionally, the disclosure of a range of values is a disclosure of every numerical value within that range, including the end points.

1. Method for manufacturing a structured cathode of an electrolytic capacitor, comprising the following steps:
a) filling an electrically conductive coating composition a micro extruder;
b) moving the micro extruder with a computer-assisted electric movement system relatively to a cathode current collector to be coated, wherein the movement system allows a relative movement between the micro extruder and the cathode current collector with at least three degrees of freedom;
c) applying the electrically conductive coating composition in a desired thickness and in a desired pattern onto the cathode current collector without contacting the cathode current collector with the micro extruder.

2. Method according to claim 1, wherein the movement system allows a relative translational movement of the micro extruder along threes axes (x, y, z) of a Cartesian coordinate system as well as an additional rotational tilting of the micro extruder (1) around a tilting axis (T).

3. Method according to claim 1, wherein the current collector is placed on a heating plate during applying the coating composition so that a coating temperature can be adjusted.

4. Method according to claim 1, wherein the cathode current collector is formed at least partly by an electrically conductive housing of the electrolytic capacitor, wherein the electrically conductive housing is preferably made or titanium or titanium alloy.

5. Method according to claim 1, wherein the electrolytic capacitor is a tantalum or niobium electrolytic capacitor.

6. Use of a micro extruder for manufacturing a structured cathode of an electrolytic capacitor by applying an electrically conductive coating composition a desired thickness and in a desired pattern onto a cathode current collector without contacting the cathode current collector with the micro extruder.

7. Method for generating a tantalum oxide layer on a tantalum electrode for a tantalum electrolytic capacitor, the method comprising the following steps:
a) providing a forming bath with a first tantalum electrode;
b) electrically connecting the first tantalum electrode to a power supply;
c) placing a second tantalum electrode on which a tantalum oxide layer is to be formed into the forming bath and electrically connecting the second tantalum electrode with the power supply;
d) applying a voltage by the power supply between the first tantalum electrode and the second tantalum electrode and thus forming an oxide layer on the second tantalum electrode.
e) in case of stopping forming of the oxide layer or discharging the second tantalum electrode, disconnect the power supply while connecting the first tantalum electrode to the second tantalum electrode via a resistor

8. Method according to claim 6, wherein the first tantalum electrode serves as cathode and that the second tantalum electrode serves as anode, when the voltage is applied by the power supply.

9. Arrangement for forming an oxide layer on a tantalum electrode for a tantalum electrolytic capacitor, comprising a container filled with a forming bath, a first tantalum electrode placed in the forming bath, a second tantalum electrode placed in the forming bath, and a power supply electrically connected to the first tantalum electrode and the second tantalum electrode,
wherein
in that a resistor is electrically connected between the first electrode and the second tantalum electrode in the case of discharging the second tantalum electrode or stopping the forming process.

10. Arrangement according to claim 9, wherein at least a surface of the container facing the forming bath is made from tantalum.

11. Method for marking a tantalum electrode, the method comprising the following steps:
a) ablating a portion of a surface of a tantalum electrode with an ultrashort pulse laser in a patterned manner, thereby generating an identifier of the tantalum electrode;
b) generating a tantalum oxide layer on the surface of the tantalum electrode.

12. Method according to claim 11, wherein step b) is carried out after step a).

13. Method according to claim 11, wherein an additional step of sintering the tantalum electrode is carried out after step a).

14. Tantalum electrode, comprising an identifier the form of a patterned surface structuring.
